(19) United States
(12) Patent Application Publication
(10) Pub. No.: US 2024/0404188 A1
(43) Pub. Date: Dec. 5, 2024

(54) MARKING-BASED PORTRAIT RELIGHTING

(71) Applicant: Adobe Inc., San Jose, CA (US)

(72) Inventors: He Zhang, Santa Clara, CA (US); Zijun Wei, San Jose, CA (US); Zhixin Shu, San Jose, CA (US); Yiqun Mei, Baltimore, MD (US); Yilin Wang, Sunnyvale, CA (US); Xuaner Zhang, Union City, CA (US); Shi Yan, San Jose, CA (US); Jianming Zhang, Fremont, CA (US)

(73) Assignee: Adobe Inc., San Jose, CA (US)

(21) Appl. No.: 18/205,279

(22) Filed: Jun. 2, 2023

(51) Int. Cl. G06T 15/50; G06T 7/11; G06T 15/04; G06T 15/60; G06T 15/80

(52) U.S. Cl. CPC G06T 15/506; G06T 7/11; G06T 15/04; G06T 15/60; G06T 15/80; G06T 2207/20081; G06T 2207/30201; G06T 2215/12

(57) ABSTRACT

In accordance with the described techniques, a portrait relighting system receives user input defining one or more markings drawn on a portrait image. Using one or more machine learning models, the portrait relighting system generates an albedo representation of the portrait image by removing lighting effects from the portrait image. Further, the portrait relighting system generates a shading map of the portrait image using the one or more machine learning models by designating the one or more markings as a lighting condition, and applying the lighting condition to a geometric representation of the portrait image. The one or more machine learning models are further employed to generate a relit portrait image based on the albedo representation and the shading map.

### BACKGROUND

Photo editing applications often include functionality for relighting an image. To implement this functionality, photo editing applications are invoked to replace the lighting conditions depicted in a digital image with different lighting conditions that are specified by a user. However, conventional image relighting techniques lack intuitive and customizable mechanisms for users to convey desired lighting conditions. In one such conventional technique, an image is relit based on the lighting conditions of a user-selected model image. However, once a model image is selected, the user lacks precise control to further fine tune the lighting conditions. In another conventional technique, an image is relit based on editable high dynamic range (HDR) environment maps. However, these HDR environment maps are unintuitive to edit, and as such, users often spend considerable time and effort learning how to manipulate an HDR environment map to produce a desired lighting condition.

### SUMMARY

Techniques for marking-based portrait relighting are described herein. In an example, a computing device implements a portrait relighting system to receive an input that includes a portrait image depicting a human subject and one or more markings drawn on the portrait image. The portrait relighting system uses a machine learning delighting model to generate an albedo representation of the portrait image by removing shadows and highlights from the portrait image. Furthermore, the portrait relighting system employs a machine learning shading model to generate a shading map by designating the one or more markings as a lighting condition, and applying the lighting condition to a geometric representation of the portrait image. The shading map, for instance, captures the lighting effects (e.g., the shadows and highlights) on the surface of the human subject that are produced by the designated lighting condition. Using a machine learning delighting model, the portrait relighting system generates a relit portrait image by transferring the lighting effects that are produced by the designated lighting condition to the albedo representation.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation that is operable to employ techniques described herein for marking based portrait relighting.

FIG. 2 depicts a system in an example implementation showing operation of a delighting module to generate an albedo representation of a portrait image.

FIG. 3 depicts a system in an example implementation showing operation of a relighting module to generate a relit portrait image.

FIG. 4 depicts a system in an example implementation showing operation of a marking simulation module to generate simulated markings from a training portrait image.

FIG. 5 depicts a system in an example implementation showing operation of a training module.

FIG. 6 depicts an example network architecture of a machine learning delighting model.

FIG. 7 depicts an example showing a network architecture of one or more machine learning models of a relighting module.

FIG. 8 is a flow diagram in an example implementation for deploying a portrait relighting system in accordance with the described techniques for marking-based relighting.

FIG. 9 is a flow diagram in an example implementation for training a portrait relighting system in accordance with the described techniques for marking-based relighting.

FIG. 10 illustrates an example system including various components of an example device that can be implemented as any type of computing device as described and/or utilize with reference to FIGS. 1-9 to implement embodiments of the techniques described herein.

### DETAILED DESCRIPTION

### Overview

Image processing systems are often implemented for image relighting tasks, which involve replacing the lighting conditions of a digital image with different lighting conditions that are specified by a user. However, conventional image relighting techniques lack intuitive and customizable mechanisms for users to convey a desired lighting condition for a relit image. One such conventional technique models the lighting conditions of a relit image based on a user-selected model image. However, this technique relies on tedious manual image search to find a model image with suitable lighting conditions. Even when a suitable image is found, the user lacks precise lighting control to further fine tune the lighting conditions. Another conventional technique relies on user manipulation of high dynamic range (HDR) environment maps to relight an image. However, HDR environment maps are unintuitive for users to edit, and as such, users implementing this conventional technique spend considerable time and effort learning how to manipulate the HDR environment map to produce a desired lighting condition.

To overcome the limitations of conventional techniques, techniques for marking-based portrait relighting are described herein. In accordance with the described techniques, a portrait relighting system receives a user input that includes a portrait image depicting a human subject, and one or more markings drawn on the portrait image. In addition, the user input includes a skin tone color value associated with the human subject depicted in the portrait image. By way of example, the user is prompted to select a color from a plurality of colors that most closely resembles the skin tone of the depicted human subject.

The portrait relighting system employs a delighting module to generate an albedo representation of the portrait image. To do so, the delighting module identifies a skin region of the portrait image that includes exposed skin, segments the skin region from other portions of the portrait image, and fills the skin region with the skin tone color value. In addition, the delighting module generates a geometric representation of the portrait image that includes a surface normal for each pixel in the portrait image that depicts the human subject, e.g., the per-pixel surface normals. In accordance with the described techniques, the delighting module leverages a machine learning delighting model, which receives the portrait image, the skin tone map, and the geometric representation as conditioning. As output, the machine learning delighting model generates a first albedo representation of the portrait image by removing lighting effects (e.g., shadows and highlights) from the portrait image. For example, the first albedo representation has the shadows and highlights caused by the lighting conditions of the portrait image removed. The delighting module further generates a second albedo representation by shifting pixel color values of the pixels in the skin region of the first albedo representation to be closer to the user-specified skin tone color value. By way of example, if a pixel in the skin region of the first albedo representation is a darker shade than the skin tone color value, the delighting module modifies the color value of the pixel to have a lighter shade.

Furthermore, the portrait relighting system employs a relighting module to generate a relit portrait image. As part of this, the relighting module leverages a machine learning albedo encoder model, a machine learning shading model, and a machine learning lighting decoder model. In particular, the second albedo representation is provided to the machine learning albedo encoder model, which encodes an albedo feature that numerically represents the second albedo representation. In addition, the machine learning shading model receives, as conditioning, the markings and the geometric representation including the per-pixel surface normals. As output, the machine learning shading model generates a shading map by designating the markings as a lighting condition, and applying the lighting condition to the geometric representation. As a result, the shading map captures how the designated lighting condition interacts with the surface of the depicted human subject. For example, the shading map includes shadows and highlights on the surface of the depicted human subject as a result of the depicted human subject blocking and reflecting the designated lighting condition.

Furthermore, the albedo feature and the shading map are concatenated to generate a combined feature, which is provided, as conditioning, to a machine learning lighting decoder model. The machine learning lighting decoder model is configured to output a relit portrait image by transferring the lighting condition, as applied to the geometric representation, to the second albedo representation. In other words, the machine learning lighting decoder model transfers the shadows and the highlights of the shading map to the second albedo representation. In this way, the original lighting conditions of the portrait image are replaced with the lighting conditions designated based on the markings.

During training, the machine learning delighting model, the machine learning albedo encoder model, the machine learning shading model, and the machine learning lighting decoder model (e.g., referred to collectively as “the machine learning models”) are trained based, in part, on differences between a training portrait image and the training portrait image as relit by the portrait relighting system based on simulated (e.g., computer-generated) markings. A marking simulation module is employed to generate the simulated markings. To do so, the marking simulation module receives a training portrait image depicting a human subject under a particular set of lighting conditions. The marking simulation module further generates a training shading map which captures the shadows and highlights on the surface of the depicted human subject caused by the particular set of lighting conditions.

Using a superpixel segmentation technique, the marking simulation module partitions the training shading map into a plurality of superpixels. Broadly, multiple ranges of brightness intensity values are defined, and each superpixel includes a contiguous cluster of pixels having a brightness intensity value that falls within a respective one of the multiple ranges. Further, each superpixel is associated with a brightness intensity value that corresponds to the average brightness intensity value of individual pixels within the superpixel. In accordance with the described techniques, the marking simulation module selects a subset of superpixels as the simulated markings drawn on the training portrait image. In particular, the subset includes a first sub-grouping of superpixels having a brightness intensity that exceeds a threshold (e.g., five percent of the superpixels associated with the highest average brightness intensity values), a second sub-grouping of superpixels having a brightness intensity that is less than a threshold (e.g., five percent of superpixels associated with the lowest average brightness intensity values), and one or more randomly selected superpixels.

The portrait relighting system is further leveraged to generate a relit training portrait image based on the simulated markings drawn on the training portrait image, in accordance with the techniques discussed above. By way of example, the portrait relighting system generates a second albedo representation of the training portrait image, designates the simulated markings as a lighting condition, and applies the lighting condition to the second albedo representation of the training portrait image. A training module is employed to calculate a loss that is based, in part, on differences between the training portrait image and the relit training portrait image. Further, the training module updates the machine learning models to minimize the loss. This process is repeated iteratively with different training images and associated simulated markings until convergence, a threshold number of iterations have completed, or a threshold number of epochs have been processed.

Notably, the user-drawn markings are often coarse and sparse, e.g., the markings are often crudely drawn with uneven curves and non-straight lines, cover a relatively small portion of the portrait image, and are scattered throughout the portrait image. By selecting the subset of superpixels (e.g., which are coarse in shape) in the described manner, the simulated markings accurately mimic the coarseness and sparsity of the user-drawn markings, without relying on manual user input to draw the markings. Accordingly, a training dataset including a sufficient number of training portrait images and associated simulated markings is generatable in a significantly reduced amount of time, as compared to techniques which rely on manual generation of training data.

Furthermore, in contrast to conventional techniques which rely on user manipulation of complex HDR environment maps, the described techniques relight a portrait image based on markings drawn by a user on the portrait image. The markings are an intuitive medium by which a desired lighting condition is conveyable by a user, and as such, users of the described portrait relighting system spend less time and effort learning how to produce a desired lighting condition, as compared to conventional techniques. Further, the markings are customizable and modifiable to fine tune the lighting condition, which contrasts with conventional techniques having relit lighting conditions that rigidly adhere to the lighting conditions of a user-selected model image. Accordingly, the described techniques generate a relit portrait image that represents a desired lighting condition with increased accuracy and reduced user training, as compared to conventional techniques.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

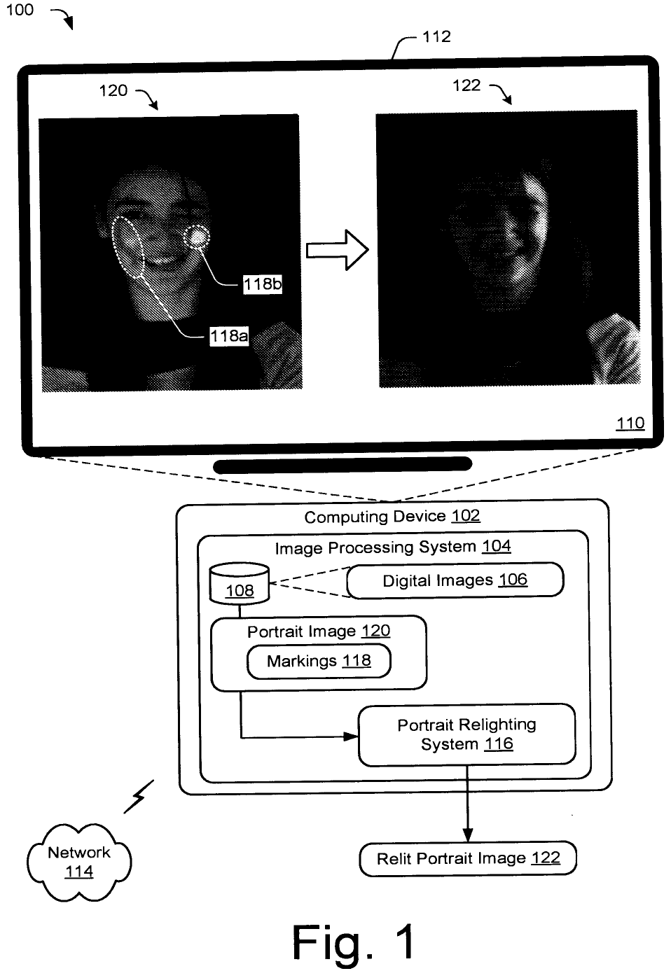

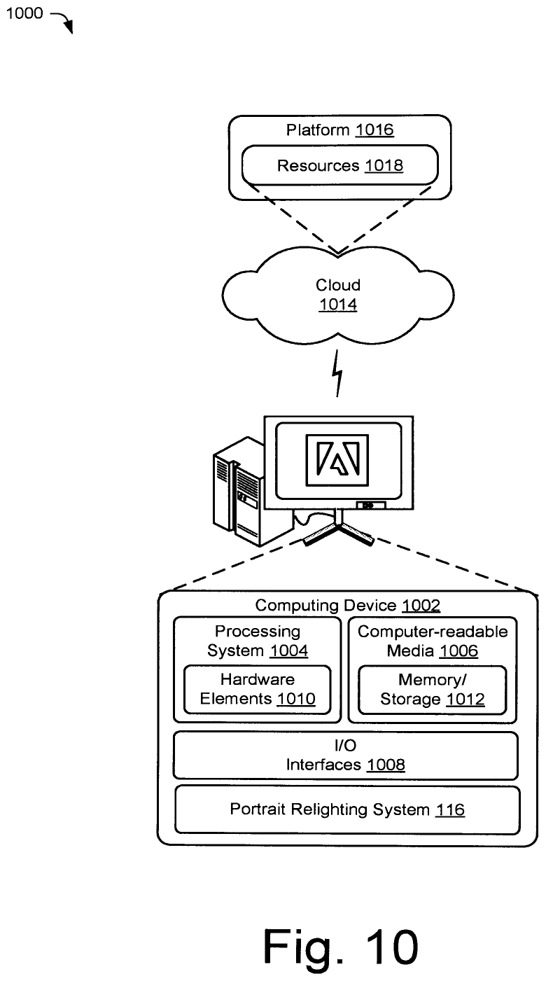

FIG. 1 is an illustration of an environment 100 in an example implementation that is operable to employ techniques described herein for marking-based portrait relighting. The illustrated environment 100 includes a computing device 102, which is configurable in a variety of ways. The computing device 102, for instance, is configurable as a desktop computer, a laptop computer, a mobile device (e.g., assuming a handheld configuration such as a tablet or mobile phone), and so forth. Thus, the computing device 102 ranges from full resource devices with substantial memory and processor resources (e.g., personal computers, game consoles) to a low-resource device with limited memory and/or processing resources (e.g., mobile devices). Additionally, although a single computing device 102 is shown, the computing device 102 is also representative of a plurality of different devices, such as multiple servers utilized by a business to perform operations “over the cloud” as described in FIG. 10.

The computing device 102 is illustrated as including an image processing system 104. The image processing system 104 is implemented at least partially in hardware of the computing device 102 to process and transform digital images 106, which are illustrated as maintained in storage 108 of the computing device 102. Such processing includes creation of the digital images 106, modification of the digital images 106, and rendering of the digital images 106 in a user interface 110 for output, e.g., by a display device 112. Although illustrated as implemented locally at the computing device 102, functionality of the image processing system 104 is also configurable as whole or part via functionality available via the network 114, such as part of a web service or “in the cloud.”

An example of functionality incorporated by the image processing system 104 to process the digital images 106 is illustrated as a portrait relighting system 116. In general, the image processing system 104 receives user input defining one or more markings 118 drawn on a portrait image 120 depicting a human subject. The portrait image 120 having the markings 118 is provided as input to the portrait relighting system 116. In one or more implementations, the portrait relighting system 116 uses machine learning to generate an albedo representation of the portrait image 120 by removing lighting effects (e.g., shadows and highlights) from the portrait image 120. Moreover, the portrait relighting system 116 uses machine learning to generate a relit portrait image 122 by designating the markings 118 as a lighting condition, and applying the lighting condition to the albedo representation.

As shown in the illustrated example, for instance, the portrait image 120 includes a first marking 118a drawn on a first side of the human subject's face and a second marking 118b drawn on a second side of the human subject's face. In particular, the first marking 118a is purple, while the second marking 118b is blue. Accordingly, the portrait relighting system 116 interprets the markings 118a, 118b as a lighting condition, and outputs a relit portrait image 122 having the lighting condition. For example, the lighting condition causes a purple lighting effect applied to the first side of the human subject's face based on the first marking 118a. In addition, the lighting condition causes a blue lighting effect applied to the second side of the human subject's face based on the second marking 118b.

In one conventional image relighting technique, an image is relit based on an editable high dynamic range (HDR) environment map. Due to the complexity of the HDR environment maps, users often spend considerable time and effort learning how to manipulate HDR environment maps to produce a desired lighting condition. In another conventional image relighting technique, an image is relit based on lighting conditions included in a user-selected model image. However, after the lighting conditions of the model image are applied, the user lacks precise lighting control to further adjust the lighting conditions. In contrast, the described techniques generate a relit portrait image 122 based on user-drawn markings 118. The markings 118 are an intuitive mechanism for a user to convey a desired lighting condition, and as such, a user of the portrait relighting system 116 is able to produce a desired lighting condition with reduced user training, as compared to conventional techniques. Further, the markings 118 are customizable and modifiable to fine tune the lighting condition applied to the relit portrait image 122, thereby enabling increased customization of the lighting condition in comparison to conventional techniques.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Portrait Relighting Features

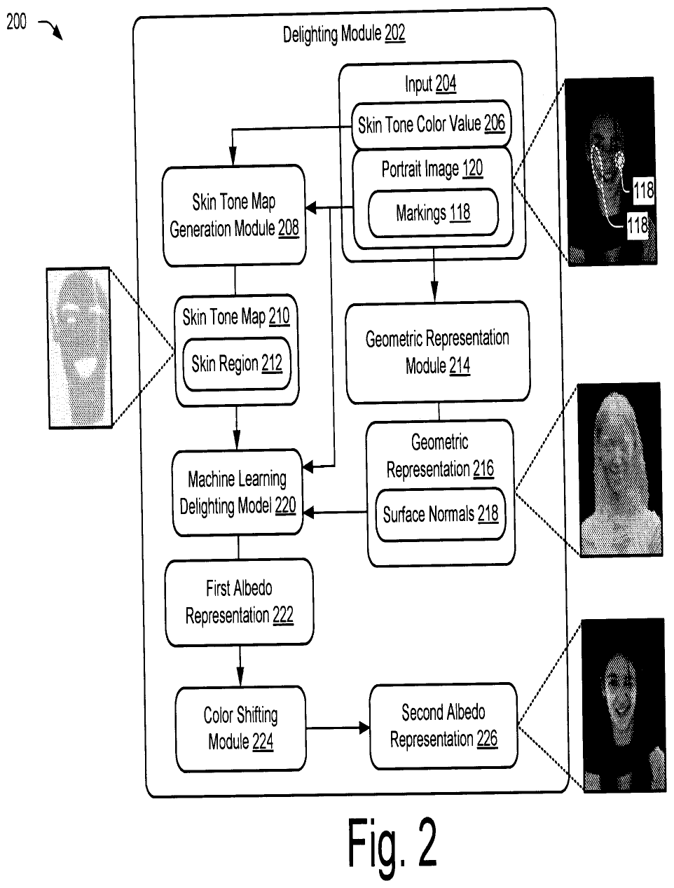

FIG. 2 depicts a system 200 in an example implementation showing operation of a delighting module 202 to generate an albedo representation of a portrait image. As shown, the delighting module 202 receives an input 204 that includes the portrait image 120, the markings 118, and a skin tone color value 206. By way of example, the portrait relighting system 116 receives user input (e.g., via the user interface 110) defining one or more markings 118 drawn on the portrait image 120. In addition, the portrait relighting system 116 receives user input (e.g., via the user interface 110) selecting a skin tone color value 206 from a plurality of skin tone color values. For example, the user interface 110 displays a plurality of colors available for selection by the user. In one or more implementations, the user is prompted to select a color from the plurality of colors that most closely resembles the true skin tone of the human subject depicted in the portrait image 120. Although depicted and described herein as a portrait image of a human subject, it is to be appreciated that the image relighting techniques described herein are implementable to relight an image that depicts any suitable object, such as an animal, an indoor environment, an outdoor environment, and an inanimate object, to name just a few.

In accordance with the described techniques, a skin tone map generation module 208 receives the skin tone color value 206 and the portrait image 120 as input. The skin tone map generation module 208 is configured to generate a skin tone map 210 having a skin region 212 of the depicted human subject filled with the skin tone color value 206. To do so, the skin tone map generation module 208 segments a skin region 212 from the portrait image 120 that includes exposed skin of the depicted human subject. Further, the skin tone map generation module 208 uniformly fills the skin region 212 with the skin tone color value 206, e.g., so each pixel in the skin region 212 has the skin tone color value 206. In one or more implementations, the portrait relighting system 116 is employed to generate a relit portrait image 122 without receiving user input specifying the skin tone color value 206. In these implementations, the skin tone map generation module 208 determines an average color value in the skin region 212 of the portrait image 120, and fills the skin region 212 with the average color value, e.g., rather than the user-specified skin tone color value 206.

Furthermore, the portrait image 120 is provided as input to a geometric representation module 214, which is configured to generate a geometric representation 216 of the portrait image 120. In particular, the geometric representation 216 includes a surface normal 218 for each pixel in the portrait image 120 that includes the human subject. Any of a variety of public or proprietary techniques are implementable by the geometric representation module 214 to determine the per-pixel surface normals 218. One such example technique is described by Bae, et al., Estimating and Exploiting the Aleatoric Uncertainty in Surface Normal Estimation, Proceedings of the IEEE/CVF International Conference on Computer Vision, 13137-13146 (2021).

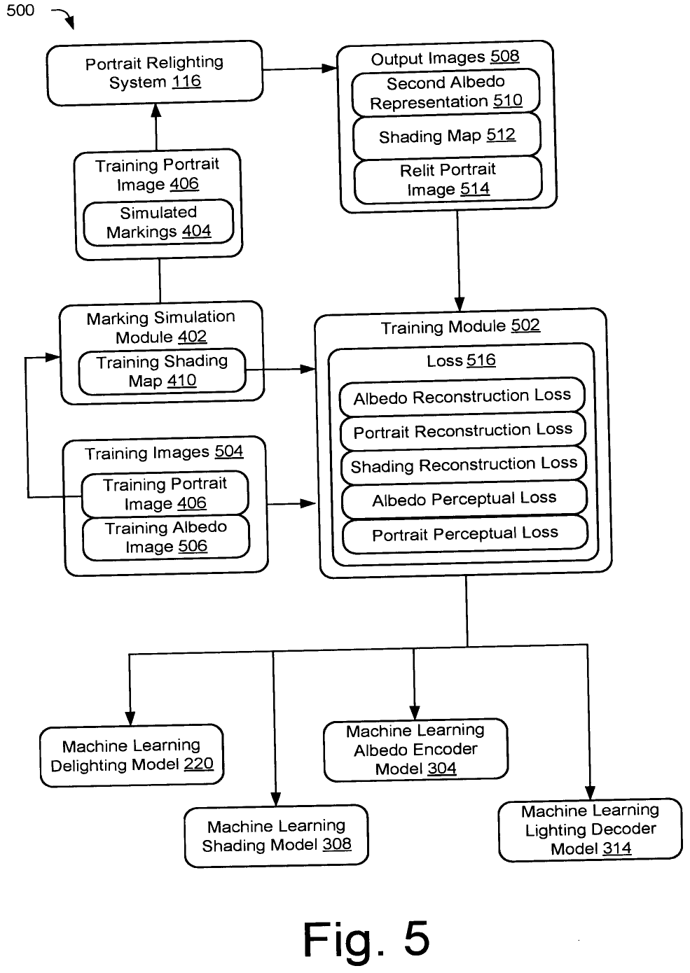

In one or more implementations, a machine learning delighting model 220 is employed to generate a first albedo representation 222 of the portrait image 120. To do so, the machine learning delighting model 220 is conditioned on the portrait image 120, the skin tone map 210, and the geometric representation 216 having the per-pixel surface normals 218. As output, the machine learning delighting model 220 generates the first albedo representation 222 by removing lighting effects (e.g., shadows and highlights) from the portrait image 120. In this way, the first albedo representation 222 corresponds to the portrait image 120 having the shadows and highlights that are caused by lighting conditions of the portrait image 120 removed. During training, the machine learning delighting model 220 is trained to remove shadows and highlights from the portrait image 120, as further discussed below with reference to FIG. 5.

The first albedo representation 222 is provided as input to a color shifting module 224, which is configured to generate a second albedo representation 226. To do so, the color shifting module 224 shifts pixel color values in the skin region 212 of the first albedo representation 222 to be closer to the skin tone color value 206. In an example in which a first pixel in the skin region 212 of the first albedo representation 222 is a lighter shade than the skin tone color value 206, the color shifting module 224 modifies the color value of the first pixel to have a darker shade. In another example in which a second pixel in the skin region 212 of the first albedo representation 222 has a darker shade than the skin tone color value 206, the color shifting module 224 modifies the color value of the second pixel to have a lighter shade. In variations, the color shifting module 224 shifts the pixel color values by up to a predetermined amount, and/or by a percentage (e.g., fifty percent) of the difference between the skin tone color value 206 and the color value of the pixel in the first albedo representation 222. In one or more implementations, the color shifting module 224 shifts the pixel color value for each pixel in the skin region 212 of the first albedo representation 222 that does not match the skin tone color value 206.

One of the foremost challenges in portrait image relighting is separating the true skin tone of the human subject from the lighting effects (e.g., shadows and highlights) in the portrait image. This challenge arises from the multitude of possible lighting conditions for a scene in combination with the significant resources that are utilized to obtain accurate labeled data that defines the lighting conditions for a scene. To alleviate this challenge, the delighting module 202 conditions the machine learning delighting model 220 on the skin tone map 210 and shifts the color values of pixels in the skin region 212 of the first albedo representation to be closer to the user-specified skin tone color value 206. By doing so, the portrait relighting system 116 leverages the user's intuitive sense of skin tone while enabling the machine learning delighting model 220 to focus on recovering the local facial details (e.g., wrinkles, skin discoloration, etc.) of the human subject.

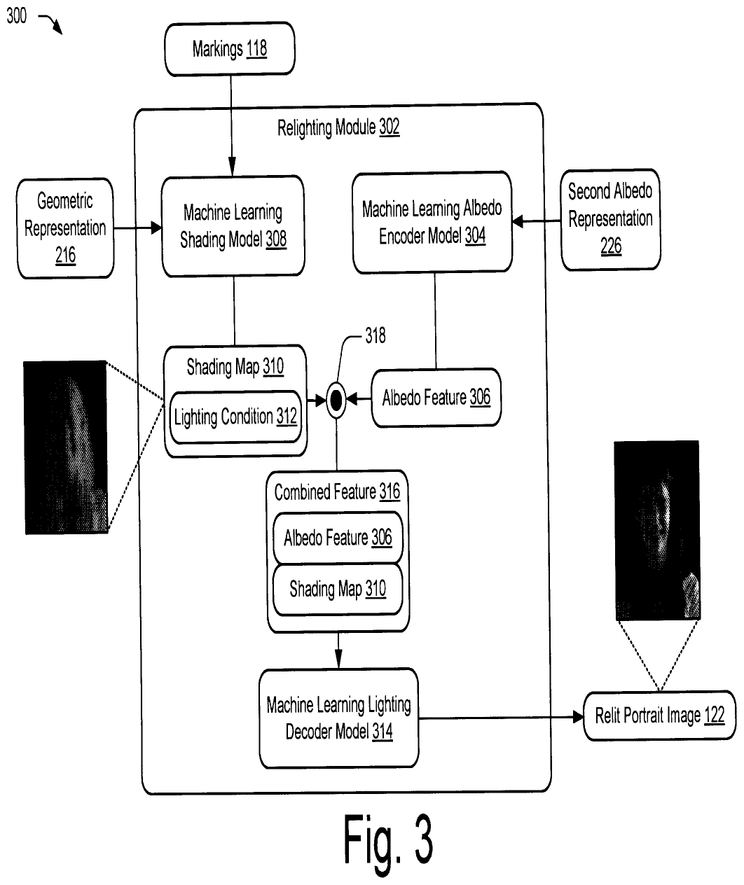

FIG. 3 depicts a system 300 in an example implementation showing operation of a relighting module 302 to generate a relit portrait image 122. As shown, the relighting module 302 includes a machine learning albedo encoder model 304, which is configured to encode an albedo feature 306 based on the second albedo representation 226. To do so, the machine learning albedo encoder model 304 is conditioned on the second albedo representation 226, and outputs an albedo feature 306 that numerically describes the second albedo representation 226 of the portrait image 120. During training, the machine learning albedo encoder model 304 is trained to encode the albedo feature 306, as further discussed below with reference to FIG. 5.

In accordance with the described techniques, a machine learning shading model 308 is employed to generate a shading map 310 of the portrait image 120. To do so, the machine learning shading model 308 receives, as conditioning, the markings 118 and the geometric representation 216 of the portrait image 120 having the per-pixel surface normals 218. Further, the machine learning shading model 308 interprets the markings 118 as a lighting condition 312, and applies the lighting condition 312 to the geometric representation 216. As a result, the machine learning shading model 308 outputs a shading map 310 that captures how the lighting condition 312 interacts with the surface of the depicted human subject. For example, the shading map 310 includes lighting effects (e.g., shadows and highlights) on the surface of the human subject produced by the surface of the depicted human subject blocking and reflecting the lighting condition 312. During training, the machine learning shading model 308 is trained to output the shading map 310, as further discussed below with reference to FIG. 5.

In one or more implementations, supervised learning is implemented to supervise the output of the machine learning shading model 308 (e.g., the shading map 310) with a ground truth shading map of the portrait image 120. To do so, the relighting module 302 generates a ground truth shading map from the portrait image 120 using any of a variety of public or proprietary techniques, an example of which is Phong shading. Generally, the ground truth shading map captures the lighting effects (e.g., shadows and highlights) caused by the lighting conditions in the portrait image 120. By supervising the shading map 310 with the ground truth, the machine learning shading model 308 propagates lighting effects from the portrait image 120 to the shading map 310. This enforces the relit portrait image 122 to be relit in a manner that is consistent with the surface geometry of the portrait image 120.

Furthermore, a machine learning lighting decoder model 314 is employed to generate the relit portrait image 122 by transferring the lighting condition 312, as applied to the geometric representation 216, to the second albedo representation 226. To do so, the relighting module 302 generates a combined feature 316 by combining the albedo feature 306 and the shading map 310. By way of example, a concatenate operation 318 is applied to the shading map 310 and the albedo feature 306 to produce a combined feature 316 including the albedo feature 306 and the shading map 310. The combined feature 316 is provided as conditioning to a machine learning lighting decoder model 314. As output, the machine learning lighting decoder model 314 generates the relit portrait image 122 having the lighting condition 312 applied to the second albedo representation 226. In other words, the machine learning lighting decoder model 314 transfers the shadows and highlights in the shading map 310 (e.g., caused by the lighting condition 312) to the second albedo representation 226.

Notably, the relighting module 302 is embodied in a two-step relighting pipeline. In a first step, the machine learning shading model 308 generates the shading map 310 conditioned on the geometric representation 216 and the markings 118. In a second step, the machine learning lighting decoder model 314 outputs the relit portrait image 122 conditioned on the combined feature 316. Accordingly, the first step designates the markings as a lighting condition 312 and incorporates the lighting condition 312 in the shading map 310, while the second step transfers the lighting condition 312 to the second albedo representation 226. The two-step relighting pipeline enables the relighting module 302 to output a relit portrait image 122 having increased realism in the lighting effects produced by the lighting condition 312, as compared to conventional techniques which relight an image in a single step by applying a lighting condition directly to an output image.

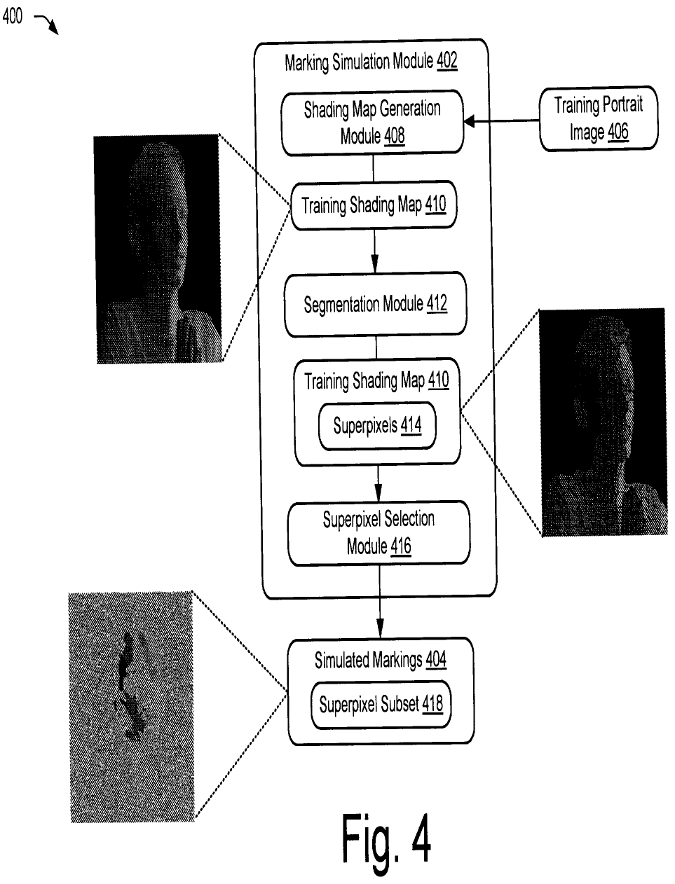

FIG. 4 depicts a system 400 in an example implementation showing operation of a marking simulation module 402 to generate simulated markings 404 from a training portrait image 406. In one or more examples, the training portrait image 406 depicts a human subject captured by a camera under a particular set of lighting conditions. As shown, a shading map generation module 408 receives the training portrait image 406 as input, and outputs a training shading map 410. The training shading map 410 captures the shadows and highlights on the surface of the depicted human subject caused by the particular set of lighting conditions. Any of a variety of public or proprietary techniques are implementable by the shading map generation module 408 to generate the training shading map 410, an example of which is Phong shading.

In accordance with the described techniques, a segmentation module 412 receives the training shading map 410, and partitions the training shading map 410 into a plurality of superpixels 414 by performing superpixel segmentation on the training shading map 410. To do so, the segmentation module 412 first converts the training shading map 410 to the LAB color space, in which the L-channel captures the luminance (e.g., brightness intensity) of the training shading map 410, the A-channel captures an amount of red/green in the training shading map 410, and the B-channel captures an amount of blue/yellow in the training shading map 410. Moreover, the segmentation module 412 is configured to coarsen the L-channel by quantizing the L-channel into multiple bins that each include a different range of L-values. Consider an example in which the training shading map 410 includes L-values ranging from forty to sixty. In this example, a first bin represents a first range of L-values (e.g., from forty to forty-three), a second bin represents a second range of L-values (e.g., from forty-four to forty-nine), a third bin represents a third range of L-values (e.g., from fifty to fifty-two), and so on, such that each distinct L-value is represented by a bin. In variations, the range of L-values for each respective bin includes a same number of distinct L-values, or the range of L-values for different bins include different numbers of distinct L-values.

Furthermore, the segmentation module 412 performs any one of a variety of public or proprietary superpixel segmentation techniques to partition the training shading map 410 into the superpixels 414. One example superpixel segmentation technique is a superpixels extracted via energy-driven sampling (SEEDS) technique, such as described by Van den Bergh et al., SEEDS: Superpixels Extracted via Energy-Driven Sampling, European Conference on Computer Vision, 13-26 (2012). As a result, each of the superpixels 414 include a contiguous cluster of pixels that are within a range of L-values associated with a respective one of the bins. Consider an example in which a bin represents L-values ranging from forty to forty-three. In this example, at least one superpixel 414 includes a contiguous cluster of pixels, such that each pixel in the cluster has a L-value that is between forty and forty-three. For each respective superpixel 414, the segmentation module 412 further calculates an average LAB color value for pixels within the respective superpixel 414. Given a superpixel 414, for instance, the segmentation module 412 calculates an average L-value, an average A-value, and an average B-value for pixels within the superpixel 414. Further, each superpixel 414 in the training shading map 410 is associated with the average LAB color value.

The training shading map 410 including the superpixels 414 is provided as input to a superpixel selection module 416. Broadly, the superpixel selection module 416 is configured to select a superpixel subset 418 as one or more simulated markings 404 drawn on the training portrait image 406. In accordance with the described techniques, the superpixel subset 418 includes one or more randomly selected superpixels 414. In a specific but non-limiting example, one or more superpixels 414 are randomly sampled using a truncated exponential distribution with a rate parameter (2) of two. In addition to the randomly selected superpixels 414, the superpixel subset 418 includes a sub-grouping of the brightest superpixels 414 (e.g., superpixels 414 having L-values that exceed a first threshold) and a sub-grouping of the darkest superpixels 414, e.g., superpixels 414 having L-values that are less than a second threshold. In some examples, the superpixel subset 418 includes a particular percentage (e.g., five percent) of the superpixels 414 having the highest L-values in the training shading map 410. In addition, the superpixel subset 418 includes a particular percentage (e.g., five percent) of the superpixels 414 having the lowest L-values in the training shading map 410. Furthermore, the superpixel selection module 416 fills the remainder of the training shading map 410 (e.g., the background and the non-selected pixels) with Gaussian noise.

Notably, the markings 118 that are drawn by a user are often coarse and sparse, e.g., the markings 118 are often crudely drawn with uneven curves and non-straight lines, cover a relatively small portion of the portrait image 120, and are scattered throughout the portrait image 120. Since the superpixels 414 are also coarse in shape, the marking simulation module 402 mimics the coarseness of user-drawn markings 118 by utilizing the superpixels 414 to generate the simulated markings 404. Further, the marking simulation module 402 mimics the sparsity of user-drawn markings 118 by selecting a subset of superpixels 414 as the simulated markings 404, and by including one or more randomly selected superpixels 414 in the superpixel subset 418.

Moreover, the superpixel selection module 416 selects areas of the human subject where shadows and highlights are often located. This is achieved through inclusion of the brightest and darkest superpixels 414 in the superpixel subset 418. Since human vision is often drawn to these areas of shadows and highlights, users typically draw the markings 118 in these areas. Therefore, the marking simulation module 402 automatically creates simulated markings 404 that accurately mimic user-drawn markings without relying on manual user input to draw the markings. By doing so, a training dataset including a plurality of training portrait images 406 and associated simulated markings 404 is generatable in a reduced amount of time, as compared to techniques which rely on manual generation of training data.

FIG. 5 depicts a system 500 in an example implementation showing operation of a training module 502. In accordance with the described techniques, a plurality of training images 504 are captured using a light stage. Broadly, the light stage includes a plurality of light sources surrounding a human subject, and the light sources are selectively illuminated to produce different lighting conditions. A training image dataset is built including a plurality of training portrait images 406, each depicting a respective one of multiple human subjects. Further, the different training portrait images 406 depict different human subjects in different poses, and with different lighting conditions produced by the light stage. For each human subject, one or more training albedo images 506 are captured with consistent lighting conditions (e.g., a particular set of light sources of the light stage illuminated) to accurately represent a skin tone of the human subject depicted in the training albedo image 506.

As shown, a pair of training images 504 are provided to the training module 502. The pair of training images includes a training portrait image 406 depicting a human subject and a corresponding training albedo image 506 also depicting the human subject. In addition, the training portrait image 406 is provided to the marking simulation module 402, which generates simulated markings 404 for the training portrait image 406 in accordance with the techniques described above with reference to FIG. 4. As part of this, the marking simulation module 402 generates the training shading map 410, which is also provided to the training module 502.

The portrait relighting system 116 receives the training portrait image 406 including the simulated markings 404, and generates output images 508. By way of example, the portrait relighting system 116 leverages the delighting module 202 to generate a second albedo representation 510 of the training portrait image 406 in accordance with the techniques described above with reference to FIG. 2. However, during training, the skin tone map 210 has the skin region 212 filled with the average skin tone color value of the training albedo image 506 rather than the user-specified skin tone color value 206. In addition, the portrait relighting system 116 employs the machine learning shading model 308 to generate a shading map 512 of the training portrait image 406 in accordance with the techniques described above with reference to FIG. 3. However, during training, the machine learning shading model 308 is conditioned on the simulated markings 404 rather than the user-drawn markings 118. Moreover, the portrait relighting system 116 employs the machine learning lighting decoder model 314 to generate a relit portrait image 514, in accordance with the techniques described above with reference to FIG. 3. During training, the machine learning lighting decoder model 314 is conditioned on a combined feature that includes the shading map 512 of the training portrait image 406, and an albedo feature of the second albedo representation 510 of the training portrait image 406. The output images 508 are provided to the training module 502.

The training module 502 uses machine learning to update the machine learning models 220, 304, 308, 314 to minimize a loss 516. Broadly, machine learning utilizes algorithms to learn from, and make predictions on, known data by analyzing the known data to learn to generate outputs that reflect patterns and attributes of the known data. By way of example, the machine learning models 220, 304, 308, 314 include layers (e.g., convolutional layers, dilated convolutional layers, and non-local operation layers), and the training module 502 updates weights associated with the layers to minimize the loss 516. In one or more implementations, the loss 516 is represented by the equation below:

[symbol]

= [symbol] _{R}_{_{ALb}}+ [symbol] _{R}_{ₚₒᵣₜ}+ [symbol] _{R}_{_{shad}}+ [symbol] _{P}_{_{Alb}}+ [symbol] _{P}_{ₚₒᵣₜ}

In the equation above, [symbol] _{R}_{_{Alb}} represents albedo reconstruction loss, [symbol] _{R}_{_{Port}} represents portrait reconstruction loss, [symbol] _{R}_{_{Shad}} represents shading reconstruction loss, LP Alb represents albedo perceptual loss, and [symbol] _{P}_{_{Port}} represents portrait perceptual loss. The training module 502 determines the albedo reconstruction loss by computing the L1 distance between the generated second albedo representation 510 and the training albedo image 506. Further, the training module 502 determines the portrait reconstruction loss by computing the L1 distance between the generated relit portrait image 514 and the training portrait image 406. Moreover, the training module 502 determines the shading reconstruction loss by computing the L1 distance between the generated shading map 512 and the training shading map 410.

In one or more implementations, the training module 502 uses a trained visual geometry group (VGG) network to determine the albedo perceptual loss and the portrait conceptual loss. Broadly, the VGG network identifies and classifies features of a subject depicted in images, e.g., eyes, eyebrows, nose, lips, and the like for an image depicting a human subject. To determine the albedo perceptual loss, the training module 502 utilizes the VGG network to compute the distance between features in the second albedo representation 510 and corresponding features in the training albedo image 506. To determine the portrait perceptual loss, the training module 502 utilizes the VGG network to compute the distance between the features in the relit portrait image 514 and corresponding features in the training portrait image 406.

After the loss 516 is computed, the training module 502 adjusts weights of layers associated with the machine learning models 220, 304, 308, 314 to minimize the loss 516. In a subsequent iteration, the training module 502 similarly adjusts the machine learning models 220, 304, 308, 314 to minimize a loss 516 computed based on a different pair of training images 504, e.g., a different training portrait image 406 and corresponding training albedo image 506. This process is repeated iteratively until the loss converges to a minimum, until a maximum number of iterations are completed, or until a maximum number of epochs have been processed. In response, the portrait relighting system 116 is deployed to generate a relit portrait image 122 based on the user-drawn markings 118.

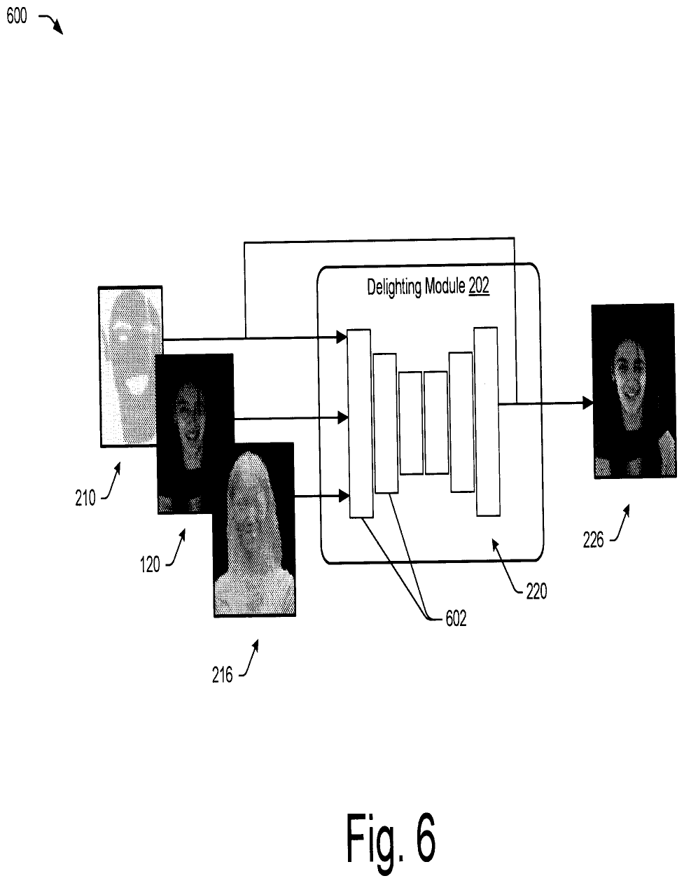

FIG. 6 depicts an example 600 showing a network architecture of a machine learning delighting model 220. As shown, the machine learning delighting model 220 receives, as conditioning, the skin tone map 210, the portrait image 120, and the geometric representation 216. In the example 600, the non-filled rectangles represent convolutional layers 602. Accordingly, in the example 600, the machine learning delighting model 220 includes three downsampling convolutional layers 602 followed by three upsampling convolutional layers 602. Moreover, the output of the machine learning delighting model 220 (e.g., the first albedo representation 222) is further modified based on the skin tone map 210. Indeed, the pixel color values in the skin region 212 of the first albedo representation 222 are modified to be closer to the user-specified skin tone color value 206. Accordingly, the output of the delighting module 202 is the second albedo representation 226.

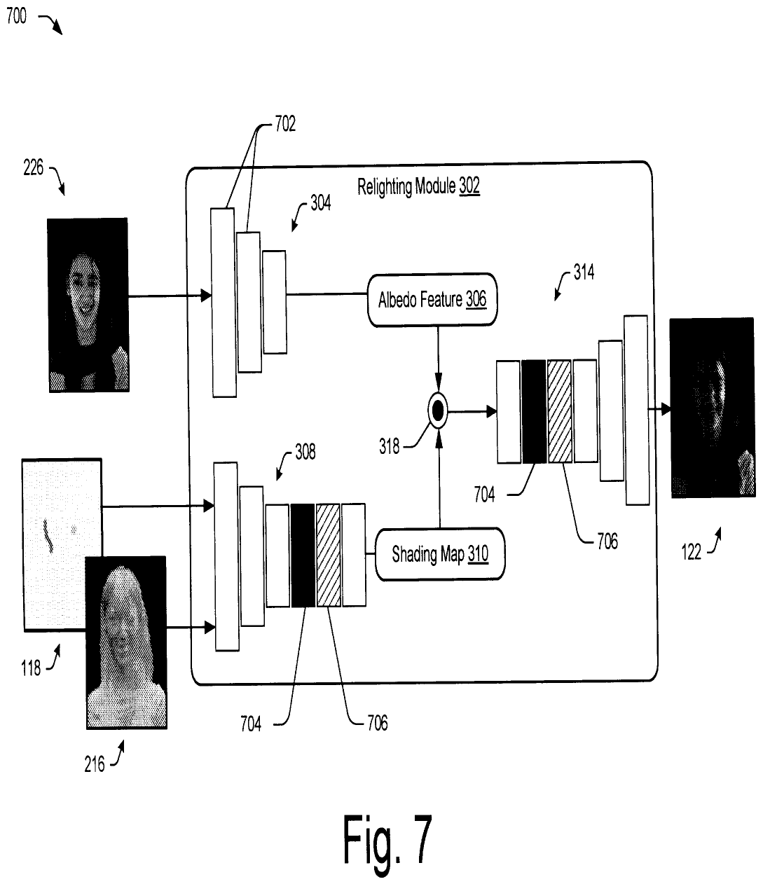

FIG. 7 depicts an example 700 showing a network architecture of one or more machine learning models 304, 308, 314 of a relighting module 302. In the depicted example 700, the non-filled rectangles represent convolutional layers 702, the filled rectangles represent dilated convolutional layers 704, and the striped rectangles represent non-local operation layers 706. As shown, the machine learning albedo encoder model 304 receives, as input, the second albedo representation 226. The input is propagated through three downsampling convolutional layers 702, and the machine learning albedo encoder model 304 outputs the albedo feature 306.

As shown, the machine learning shading model 308 receives, as input, the markings 118 and the geometric representation 216. The input is propagated through three downsampling convolutional layers 702, a dilated convolutional layer 704, a non-local operation layer 706, and an additional convolutional layer 702. In accordance with the described techniques, the machine learning shading model outputs the shading map 310. Further, the albedo feature 306 and the shading map 310 are concatenated (e.g., via the concatenate operation 318) to generate the combined feature 316, which is provided as input to the machine learning lighting decoder model 314. The input is propagated through a first convolutional layer 702, a dilated convolutional layer 704, a non-local operation layer 706, and three additional upsampling convolutional layers 702. Moreover, the machine learning lighting decoder model 314 outputs the relit portrait image 122. Although the machine learning models 220, 304, 308, 314 of FIGS. 6 and 7 are depicted as including a certain number of convolutional layers, dilated convolutional layers, and non-local operation layers, it is to be appreciated that the machine learning models 220, 304, 308, 314 include different numbers of convolutional layers, dilated convolutional layers, and non-local operation layers in variations.

Accordingly, in the examples 600, 700, the machine learning models 220, 304, 308, 314 form a U-Net convolutional neural network (CNN). However, the U-Net CNN embodied by the described machine learning models 220, 304, 308, 314 is augmented with one or more additional dilated convolutional layers and one or more additional non-local operation layers. This contrasts with the standard U-Net CNN architecture utilized by conventional techniques for image relighting.

As previously mentioned, the user-drawn markings 118 are often sparse and local, e.g., the markings 118 cover a relatively small portion of the portrait image 120 and are scattered throughout the portrait image 120. In contrast, lighting is a global effect, e.g., lighting conditions effect all portions of the portrait image 120. Broadly, the dilated convolutional layers 704 have an expanded receptive field, as compared to standard convolutional layers. Furthermore, in contrast to standard convolutional layers which iteratively process local neighborhoods of an image, the non-local operation layers 706 capture the response of the markings 118 (e.g., the shadows and highlights caused by the lighting condition 312) at other positions in an image, regardless of how remote the other positions are. Accordingly, the dilated convolutional layers 704 and the non-local operation layers 706 enable the portrait relighting system 116 to capture the effects of the lighting condition 312 in a global context from local and sparse user-drawn markings 118. In this way, the described network architecture interprets the local and sparse user-drawn markings 118 with increased accuracy, as compared to conventional techniques which implement the standard U-Net architecture.

### Example Procedures

The following discussion describes techniques that are implementable utilizing the previously described systems and devices. Aspects of each of the procedures are implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-7.

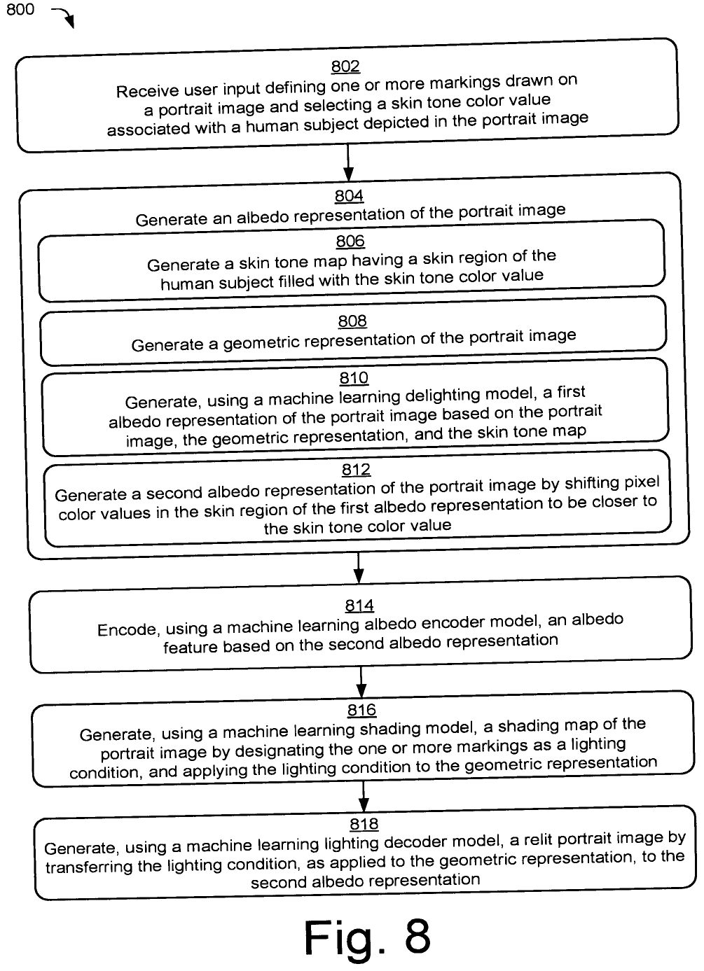

FIG. 8 depicts a procedure 800 in an example implementation for deploying a portrait relighting system in accordance with the described techniques for marking-based relighting. User input is received defining one or more markings drawn on a portrait image and selecting a skin tone color value associated with a human subject depicted in the portrait image (block 802). By way of example, the delighting module 202 receives the input 204 that includes the portrait image 120, the markings 118 drawn on the portrait image 120, and the skin tone color value 206.

An albedo representation of the portrait image is generated (block 804). By way of example, the delighting module 202 is employed to generate the second albedo representation 226. As part of this, a skin tone map is generated having a skin region of the human subject filled with the skin tone color value (block 806). For instance, the skin tone map generation module 208 identifies a skin region 212 of the portrait image 120 that includes exposed skin of the human subject. Further, the skin tone map generation module 208 fills the skin region 212 with the skin tone color value 206. Moreover, a geometric representation of the portrait image is generated (block 808). For example, the geometric representation module 214 generates the geometric representation 216 of the portrait image 120 that includes a surface normal 218 for each pixel in the portrait image 120 that depicts the human subject.

A first albedo representation is generated using a machine learning delighting model based on the portrait image, the geometric representation, and the skin tone map (block 810). By way of example, the machine learning delighting model 220 receives, as conditioning, the portrait image 120, the skin tone map 210, and the geometric representation having the per-pixel surface normals 218. Further, the machine learning delighting model 220 outputs the first albedo representation 222 by removing the shadows and highlights from the portrait image 120. Moreover, a second albedo representation of the portrait image is generated by shifting pixel color values in the skin region of the first albedo representation to be closer to the skin tone color value (block 812). For instance, the color shifting module 224 is employed to generate the second albedo representation 226 by shifting pixel color values in the skin region 212 to be closer to the user-specified skin tone color value 206.

An albedo feature is encoded using a machine learning albedo encoder model based on the second albedo representation (block 814). Indeed, the machine learning albedo encoder model 304 receives the second albedo representation 226 as conditioning, and outputs an albedo feature 306 that numerically describes the second albedo representation 226. A shading map of the portrait image is generated using a machine learning shading model by designating the one or more markings as a lighting condition, and applying the lighting condition to the geometric representation (block 816). For example, a machine learning shading model 308 receives the markings 118 and the geometric representation 216 as conditioning. Further, the machine learning shading model 308 designates the markings as a lighting condition 312, and applies the lighting condition to the geometric representation 216. In this way, shading map 310 includes lighting effects (e.g., shadows and highlights) on the surface of the human subject as a result of the lighting condition 312, as designated based on the markings 118.

A relit portrait image is generated using a machine learning lighting decoder model by transferring the lighting condition, as applied to the geometric representation, to the second albedo representation (block 818). For instance, the albedo feature 306 and the shading map 310 are combined to generate a combined feature, which is provided as conditioning to the machine learning lighting decoder model 314. Further, the machine learning lighting decoder model 314 transfers the shadows and highlights caused by the lighting condition 312 (e.g., and included in the shading map 310) to the second albedo representation 226.

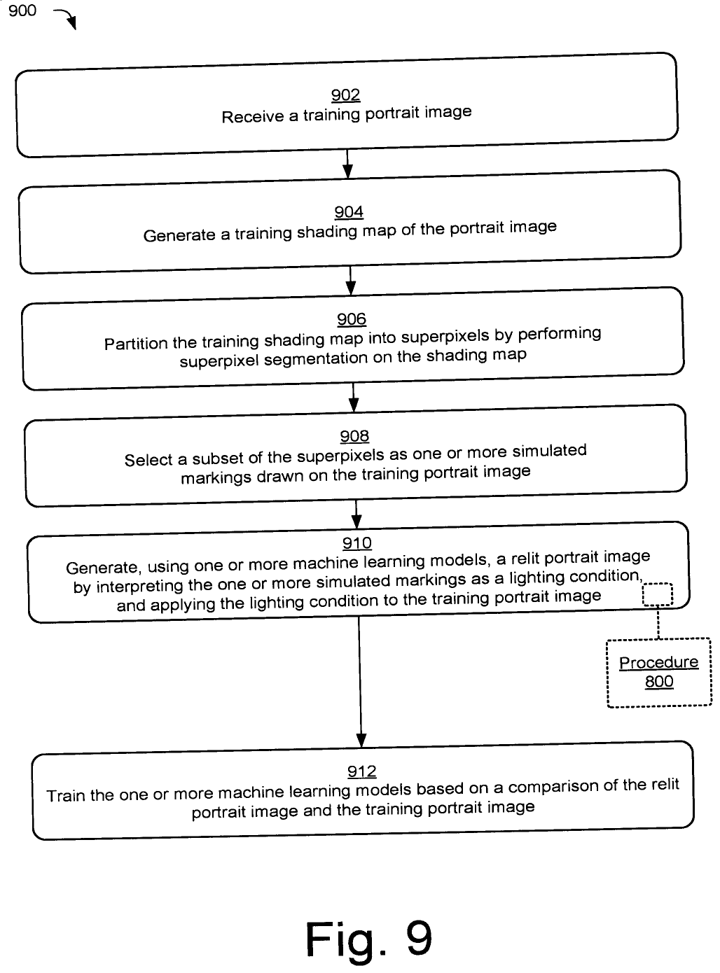

FIG. 9 depicts a procedure 900 in an example implementation for training a portrait relighting system in accordance with the described techniques for marking-based relighting. A training portrait image is received (block 902). By way of example, the portrait relighting system 116 receives a training portrait image 406 depicting a human subject as exposed to a particular set of lighting conditions. A training shading map of the training portrait image is generated (block 904). For example, the shading map generation module 408 is leveraged to generate a training shading map 410 of the training portrait image 406 that includes lighting effects (e.g., shadows and highlights) caused by the particular set of lighting conditions.

The training shading map is partitioned into superpixels by performing superpixel segmentation on the shading map (block 906). Indeed, the segmentation module 412 quantizes the training shading map 410 into bins that define ranges of brightness intensity values. Further, the segmentation module 412 performs superpixel segmentation on the training shading map, thereby creating a plurality of superpixels 414. As a result, a respective superpixel 414 includes a contiguous cluster of pixels, such that the brightness intensity value of each pixel in the respective superpixel 414 is within a respective one of the ranges. A subset of superpixels is selected as one or more simulated markings drawn on the training portrait image (block 908). For instance, the superpixel selection module 416 selects a superpixel subset 418 that includes one or more randomly selected superpixels 414, a grouping of superpixels 414 having a brightness intensity that exceeds a first threshold, and a grouping of superpixels 414 having a brightness intensity value that is less than a second threshold.

A relit portrait image is generated using one or more machine learning models by interpreting the one or more simulated markings as a lighting condition, and applying the lighting condition to the training portrait image (block 910). For example, the portrait relighting system 116 uses the machine learning models 220, 304, 308, 314 to interpret the simulated markings 404 as a lighting condition 312, and apply the lighting condition to the training portrait image 406. In one or more examples, the portrait relighting system 116 utilizes the procedure 800 to generate a relit training portrait image. The one or more machine learning models are trained based on a comparison of the relit portrait image and the training portrait image (block 912). By way of example, the training module 502 updates the machine learning models 220, 304, 308, 314 to minimize the loss 516 based, in part, on differences between the training portrait image 406 and the relit training portrait image.

### Example System and Device

FIG. 10 illustrates an example system generally at 1000 that includes an example computing device 1002 that is representative of one or more computing systems and/or devices that implement the various techniques described herein. This is illustrated through inclusion of the portrait relighting system 116. The computing device 1002 is configurable, for example, as a server of a service provider, a device associated with a client (e.g., a client device), an on-chip system, and/or any other suitable computing device or computing system.

The example computing device 1002 as illustrated includes a processing system 1004, one or more computer-readable media 1006, and one or more I/O interface 1008 that are communicatively coupled, one to another. Although not shown, the computing device 1002 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware element 1010 that is configurable as processors, functional blocks, and so forth. This includes implementation in hardware as an application specific integrated circuit or other logic device formed using one or more semiconductors. The hardware elements 1010 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1006 is illustrated as including memory/storage 1012. The memory/storage 1012 represents memory/storage capacity associated with one or more computer-readable media. The memory/storage 1012 includes volatile media (such as random access memory (RAM)) and/or nonvolatile media (such as read only memory (ROM), Flash memory, optical disks, magnetic disks, and so forth). The memory/storage 1012 includes fixed media (e.g., RAM, ROM, a fixed hard drive, and so on) as well as removable media (e.g., Flash memory, a removable hard drive, an optical disc, and so forth). The computer-readable media 1006 is configurable in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1002. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1002, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1010. The computing device 1002 is configured to implement particular instructions and/or functions corresponding to the software and/or hardware modules. Accordingly, implementation of a module that is executable by the computing device 1002 as software is achieved at least partially in hardware, e.g., through use of computer-readable storage media and/or hardware elements 1010 of the processing system 1004. The instructions and/or functions are executable/operable by one or more articles of manufacture (for example, one or more computing devices 1002 and/or processing systems 1004) to implement techniques, modules, and examples described herein.

The techniques described herein are supported by various configurations of the computing device 1002 and are not limited to the specific examples of the techniques described herein. This functionality is also implementable all or in part through use of a distributed system, such as over a “cloud” 1014 via a platform 1016 as described below.

The cloud 1014 includes and/or is representative of a platform 1016 for resources 1018. The platform 1016 abstracts underlying functionality of hardware (e.g., servers) and software resources of the cloud 1014. The resources 1018 include applications and/or data that can be utilized while computer processing is executed on servers that are remote from the computing device 1002. Resources 1018 can also include services provided over the Internet and/or through a subscriber network, such as a cellular or Wi-Fi network.

The platform 1016 abstracts resources and functions to connect the computing device 1002 with other computing devices. The platform 1016 also serves to abstract scaling of resources to provide a corresponding level of scale to encountered demand for the resources 1018 that are implemented via the platform 1016. Accordingly, in an interconnected device embodiment, implementation of functionality described herein is distributable throughout the system 1000. For example, the functionality is implementable in part on the computing device 1002 as well as via the platform 1016 that abstracts the functionality of the cloud 1014.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method, comprising:
receiving user input defining one or more markings drawn on a portrait image;
generating, using one or more machine learning models, an albedo representation of the portrait image by removing lighting effects from the portrait image;
generating, using the one or more machine learning models, a shading map of the portrait image by:
designating the one or more markings as a lighting condition; and
applying the lighting condition to a geometric representation of the portrait image; and
generating, using the one or more machine learning models, a relit portrait image based on the albedo representation and the shading map.

2. The method of claim 1, wherein the lighting effects include shadows and highlights of the portrait image.

3. The method of claim 1, wherein the geometric representation of the portrait image includes a surface normal for each pixel in the portrait image that includes a human subject.

4. The method of claim 3, wherein the generating the albedo representation includes:
receiving user input specifying a skin tone color value;
identifying a region of the portrait image that includes exposed skin of the human subject; and
generating a skin tone map having the region filled with the skin tone color value.

5. The method of claim 4, wherein the generating the albedo representation includes:
conditioning the one or more machine learning models on the portrait image, the geometric representation, and the skin tone map; and
generating, using the one or more machine learning models, a first albedo representation of the portrait image having the lighting effects removed.

6. The method of claim 5, wherein the generating the albedo representation includes shifting pixel color values in the region of the first albedo representation to be closer to the skin tone color value.

7. The method of claim 1, wherein the generating the relit portrait image includes encoding, using the one or more machine learning models, an albedo feature conditioned on the albedo representation.

8. The method of claim 7, wherein the generating the relit portrait image includes:
generating a combined feature of the portrait image by combining the albedo feature with the shading map; and
conditioning the one or more machine learning models on the combined feature.

9. The method of claim 1, wherein the one or more machine learning models include one or more U-Net convolutional neural networks augmented with one or more additional dilated convolutional layers.

10. The method of claim 1, wherein the one or more machine learning models include one or more U-Net convolutional neural networks augmented with one or more additional non-local operation layers.

11. The method of claim 1, further comprising:
receiving a training portrait image;
generating one or more simulated markings drawn on the training portrait image;
generating, using the one or more machine learning models, an additional relit portrait image by designating the one or more simulated markings as an additional lighting condition, and applying the additional lighting condition to the training portrait image; and
training the one or more machine learning models based on a comparison of the training portrait image and the additional relit portrait image.

12. The method of claim 11, wherein the generating the one or more simulated markings includes:
generating a training shading map of the training portrait image;
partitioning the training shading map into superpixels by performing superpixel segmentation on the training shading map; and
selecting a subset of the superpixels as the one or more simulated markings.

13. A system, comprising:
a processing device; and
a computer-readable storage media storing instructions that, responsive to execution by the processing device, cause the processing device to perform operations including:
receiving user input defining one or more markings input with respect to a portrait image and selecting a skin tone color value associated with a human subject depicted in the portrait image;
generating, using one or more machine learning models, an albedo representation of the portrait image that captures a skin tone of the human subject based on the skin tone color value; and
generating, using the one or more machine learning models, a relit portrait image by:
designating the one or more markings as a lighting condition; and
applying the lighting condition to the albedo representation of the portrait image.

14. The system of claim 13, wherein the generating the albedo representation includes:
identifying a region of the portrait image that includes exposed skin of the human subject; and
generating a skin tone map having the region filled with the skin tone color value.

15. The system of claim 14, wherein the generating the albedo representation includes:
conditioning the one or more machine learning models on the portrait image, the skin tone map, and a geometric representation of the portrait image that includes a surface normal for each pixel in the portrait image depicting the human subject; and
generating, using the one or more machine learning models, a first albedo representation of the portrait image.

16. The system of claim 15, wherein the generating the albedo representation includes shifting pixel color values in the region of the first albedo representation to be closer to the skin tone color value.

17. The system of claim 13, wherein the generating the relit portrait image includes:
generating, using the one or more machine learning models, a shading map of the portrait image by applying the lighting condition to a geometric representation of the portrait image; and
transferring the lighting condition as applied to the geometric representation to the albedo representation.

18. A non-transitory computer-readable medium storing executable instructions, which when executed by a processing device, cause the processing device to perform operations comprising:
receiving a training portrait image;
generating a shading map of the training portrait image;
partitioning the shading map into superpixels by performing superpixel segmentation on the shading map;
selecting a subset of the superpixels as one or more simulated markings drawn on the training portrait image;
generating, using one or more machine learning models, a relit portrait image by:
designating the one or more simulated markings as a lighting condition; and
applying the lighting condition to the training portrait image; and
training the one or more machine learning models based on a comparison of the relit portrait image and the training portrait image.

19. The non-transitory computer-readable medium of claim 18, wherein each respective superpixel has a color value corresponding to an average color value of individual pixels of the shading map included in the respective superpixel.

20. The non-transitory computer-readable medium of claim 18, wherein the subset of the superpixels includes a first sub-grouping of one or more superpixels having a brightness intensity that exceeds a first threshold, a second sub-grouping of one or more superpixels having a brightness intensity that is less than a second threshold, and at least one randomly selected superpixel.
